(19) United States
(12) Patent Application Publication
(10) Pub. No.: US 2025/0312638 A1
(43) Pub. Date: Oct. 9, 2025

(54) CONTROL PANEL OF A FIRE PROTECTION SYSTEM HAVING SMOKE CONTROL CAPABILITES

(71) Applicant: Siemens Industry, Inc., Alpharetta, GA (US)

(72) Inventor: Francois Bronsard, Kingston, NJ (US)

(73) Assignee: Siemens Industry, Inc., Alpharetta, GA (US)

(21) Appl. No.: 18/626,568

(22) Filed: Apr. 4, 2024

(51) Int. Cl. A62C 37/38; G08B 17/10

(52) U.S. Cl. CPC A62C 37/38; G08B 17/10

(57) ABSTRACT

The disclosure relates a control panel of a fire protection system, and a method thereof, having multiple smoke controllers. The smoke controllers correspond to zones of a facility. An alarm condition of the fire protection system is detected. An exhaust mode for a first smoke controller is entered, including activating exhaust effects and deactivating supply effects, in response to determining that an exhaust cause of the first smoke controller is active. A pressurize mode for a second smoke controller is entered, including activating the supply effects and deactivating the exhaust effects, in response to determining that an exhaust cause of the second smoke controller is non-active and a pressurize cause of the second smoke controller is active. The exhaust mode of the first smoke controller and the pressurize mode of the second smoke controller are maintained in a stable active mode.

### TECHNICAL FIELD

This application relates to the field of fire protection systems and, more particularly, to fire panels of fire protection systems having smoke controllers.

### BACKGROUND

Fire Alarm Control Panels (FACP) are essential components of commercial buildings, responsible for detecting and notifying occupants of hazardous events such as fires or gas leaks. They also play a crucial role in alerting the fire department when such events occur. Additionally, FACPs can be utilized to activate fire suppression systems, close fire doors, turn off fans and dampers, and broadcast alerts and messages through the speaker system.

Building codes often require smoke control capabilities in FACPs, particularly in high-rise buildings and malls. Smoke control systems, as defined by NFPA 92A, utilize mechanical fans to create pressure differences across smoke barriers, thereby inhibiting the movement of smoke and reducing fire propagation. The main objective of these systems is to minimize smoke spread while ensuring clear paths of exit for safe evacuation.

Smoke zones are defined as physical areas separated by smoke barriers. In case of a fire, a smoke zone can be put in either exhaust mode or pressurize mode. In exhaust mode, the smoke control system expels air and smoke from the zone to the outside, while preventing fresh air from entering. In pressurize mode, fresh air is pumped into the zone to create a high-pressure state, while air and smoke from other zones are blocked from entering. Once a fire is detected, deciding which zones to put in exhaust mode and which to put in pressurize mode, and for how long, is called the smoke control strategy. For example, a common strategy called “One exhaust—Others pressurized” sets the zone where the fire is first detected in exhaust mode, while all other zones are in pressurize mode. This strategy contains the fire at its point of origin and minimizes the spread of smoke to the other areas of the building, giving more time to the occupants to evacuate. Accurately defining and executing the smoke control strategy is crucial to meet the goals of reducing smoke propagation and facilitating safe evacuation during a fire.

Providing smoke control capabilities in FACPs requires the ability to define and execute smoke control strategies. This means that when configuring the FACP, one must specify all the elements involved in the smoke control strategy, together with the execution process that will realize the strategy. In other words, it should be possible to define the various smoke zones, assign smoke devices to zones, and determine whether those devices support exhaust mode or pressurize mode. The smoke control strategy should also be specified in a way that the FACP can execute it. This is challenging to achieve in typical fire control systems because of the limitations of the control capabilities of those systems. In a typical fire control system, the devices are usually controlled individually, or as a group of closely related devices, and the control mechanism is often only able to check the local alarm conditions and a few global indicators. However, smoke control strategies require consideration of multiple local, area-wide, and global conditions, making the strategies difficult to express accurately in a typical fire control system. For example, an exhaust smoke device should activate if there is a local fire alarm in the zone, but not if the zone is already in pressurize mode due to an adjacent zone being in alarm. Therefore, controlling that smoke device correctly requires evaluating both its local alarm conditions and the current state of nearby smoke zones.

System technicians responsible for implementing a smoke control strategy in a FACP face multiple challenges. They need to coordinate the execution of the smoke control strategy across all devices in all smoke zones of the system. They must also ensure the stability of the strategy, that is, they must ensure that smoke devices do not change their behavior in response to local events unless it aligns with the overall strategy. Also, the specification of the strategy must be manageable, that is, not too costly to write, test, and maintain.

A common solution is to include in the system configuration “indicator” control elements, either global or associated with each smoke zone, that are used to indicate if the zone has been already activated according to the smoke control strategy. These elements can then be checked by the elements controlling the individual smoke control devices prior to activation or deactivation to insure the stability of the strategy.

This approach works well; however, it is challenging to implement correctly: each device control element must check exactly those indicator elements required to execute the smoke strategy as it relates to that device. Selecting the correct indicators to check is a tedious and error-prone process that requires extensive verification and testing. Another challenge of implementing this approach is setting the timing that determines when the indicator elements are set and when they are checked. This timing is critical to ensure that a device's change of state is not incorrectly blocked because some indicator element was set too early.

### SUMMARY

In accordance with one embodiment of the disclosure, there is provided a modular smoke controller approach for building management systems. The approach streamlines the design and implementation of smoke control strategies in FACPs and enhances efficiency while minimizing programming errors. The approach augments existing FACP programming tool to easily add smoke control capability to a FACP.

One aspect is a method of a control panel of a fire protection system having multiple smoke controllers in which the smoke controllers correspond to multiple zones of a facility. An alarm condition of the fire protection system is detected. An exhaust mode for a first smoke controller of the smoke controllers is entered in response to determining that an exhaust cause of the first smoke controller is active. Entering the exhaust mode includes activating exhaust effects and deactivating supply effects. A pressurize mode for a second smoke controller of the smoke controllers is entered in response to determining that an exhaust cause of the second smoke controller is non-active and a pressurize cause of the second smoke controller is active. Entering the pressurize mode includes activating the supply effects and deactivating the exhaust effects. The exhaust mode of the first smoke controller and the pressurize mode of the second smoke controller are maintained in a stable active mode.

Another aspect is a control panel of a fire protection system comprising multiple smoke controllers, an input component, and a processor. The smoke controllers correspond to multiple zones of a facility. The input component detects an alarm condition of the fire protection system. The processor enters an exhaust mode for a first smoke controller of the smoke controllers in response to determining that an exhaust cause of the first smoke controller is active. The processor enters a pressurize mode for a second smoke controller of the smoke controllers in response to determining that an exhaust cause of the second smoke controller is non-active and a pressurize cause of the second smoke controller is active. The processor maintains the exhaust mode of the first smoke controller and the pressurize mode of the second smoke controller in a stable active mode. The exhaust mode is entered by activating exhaust effects and deactivating supply effects. The pressurize mode is entered by activating the supply effects and deactivating the exhaust effects.

Yet another aspect is a non-transitory computer readable medium including executable instructions which, when executed, causes at least one processor to manage multiple smoke controllers for a control panel of a fire protection system in accordance with the method described above.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 is a system diagram illustrating a fire protection system in an example implementation that is operable to employ techniques described herein.

FIG. 2 illustrates an example implementation of the fire protection system of FIG. 1 in response to an alarm.

FIG. 3A and 3B illustrate example implementations of the fire protection system of FIG. 1 in response to a subsequent alarm or manual alarm, respectively.

FIG. 4 is a block diagram of the control panel of FIG. 1 in an example implementation.

FIG. 5 is a flow diagram of a smoke control operation of a smoke controller of a control panel in an example implementation.

FIG. 6 is a flow diagram of an exhaust mode of the smoke controller of FIG. 5 in an example implementation.

FIG. 7 is a flow diagram of a pressurize mode of the smoke controller of FIG. 5 in an example implementation.

FIG. 8 is a flow diagram representing a configuration operation for configuring the smoke control operation of FIG. 5 an example implementation.

### DETAILED DESCRIPTION

Various technologies that pertain to systems and methods that facilitate smoke control capabilities of a fire protection system will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

A smoke zone control system provides several performance, efficiency, and cost advantages compared to known solutions/products. By incorporating the control of both the exhaust and supply devices within the same control element, the system ensures seamless coordination between them. This eliminates potential issues or discrepancies that may arise when using separate control elements for the devices. Smoke devices within the same zone are properly coordinated, enhancing the overall performance of the smoke control system.

The system simplifies the task of ensuring the stability of the smoke control strategy. The system's event evaluation mechanism is designed to react to new events only if the original trigger events become false. This means that once the control is activated, it will remain in the selected mode unless the initial trigger condition is no longer met. Again, such stability at the zone level is difficult to achieve when using separate control elements for smoke devices. With unified control, the overall stability of the smoke control strategy becomes easier to ensure and maintain.

Additionally, the system employs a technique where the negation of the exhaust conditions is implicitly added to the pressurize conditions. This approach greatly simplifies the task of specifying the pressurize trigger conditions for the smoke zone. Technicians can now write expansive pressurize conditions without the concern of overlapping with and contradicting the exhaust conditions. This simplification streamlines system configuration, reducing complexity and potential conflicts, ultimately leading to cost savings in terms of setup and maintenance.

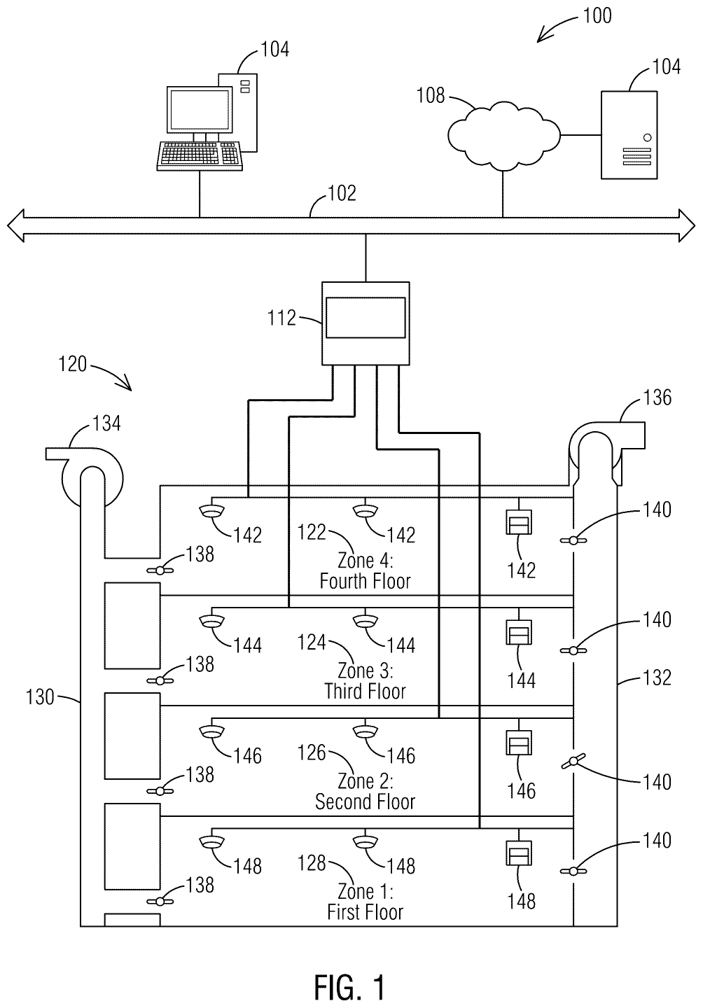

Referring to FIG. 1, there is shown an example network topology of a fire protection system 100. The system 100 comprises one or more network connections or primary buses 102 for connectivity to components of a management level network (“MLN”) of the system 100. For one embodiment, the example system 100 may comprise one or more management workstations 104 connecting through a wired or wireless network, that allows the setting and/or changing of various controls of the system 100. A management workstation 104 may also be a remote server or computing device communicating via a network cloud 108. The management workstation 110 may further be a portable management workstation connecting through a wired or wireless link to a workstation, field level device, or network interface of the system 100. While a brief description of the system 100 is provided below, it will be understood that the system described herein is only one example of a simplified form or configuration for a system. The system 100 may be implemented in any other suitable manner without departing from the scope of this disclosure.

The fire protection system 100 includes one or more control panels 112 that monitors and manages the mechanical, electrical, electromechanical, and other services in a facility 120. The facility is divided into multiple fire areas or zones 122-128 in which each zone has fire protection measures, such as walls, doors, and windows, and field devices, such sensors and operation panels. The control panel 112 monitors and controls the field devices to provide the fire protection services.

The fire protection system 100 operations in conjunction with an HVAC unit 120 of the facility, which provides comfort conditions, such as temperature, humidity, and ventilation, within the zones 122-128 of the facility. The HVAC unit 120 includes supply conduits 130 and return conduits 132 that direct airflow through the zones 122-128 via fans 134, 136 of the HVAC unit. Ventilation in each zone 122-128 is controlled by airflow controllers, such as dampers or valves, that regulate airflow from the supply duct 130 into the zones and to the return duct 132 out of the zones. For example, as illustrated in FIG. 1, supply dampers 138 may control the incoming airflow into the zones 122-128 and exhaust dampers 140 may control the outgoing airflow out of the zones.

The fire protection system 100 includes one or more control panels 112 and multiple field devices 142-148 distributed throughout the zones 122-128 of the facility, in which the control panels 112 control the field devices 142-148. For one embodiment, each floor of a facility may be designated as a zone 122-128 in which zone 1 (128) is the first floor, zone 2 (126) is the second floor, zone 3 (124) is the third floor, and zone 4 (122) is the fourth floor. Zone 4 (122) may include a fourth floor field devices 142, zone 3 may include third floor field devices 144, zone 2 may include second floor field devices 146, and zone 1 may include first floor field devices 148. Example of field device at each zone 122-128 monitored and controlled by the control panel 112 include, but are not limited to, smoke detectors, heat detectors, pull stations, sprinklers, and HVAC control devices.

FIG. 1 represents an active and normal state of the fire protection system 100 in which air flows in and out of each zone 122-128. The smoke control system uses two types of elements to define its control logic: smoke zone control and smoke device control. Smoke zone control elements implement the smoke control strategy, while smoke device control elements allow for manual control and monitoring of individual smoke devices. The control panel 112 includes a smoke device control element for each smoke device or group of devices. The physical output channels that control the smoke devices are assigned to the effects element of the smoke device control element. In addition, the input channels that correspond to the smoke device's position sensors is assigned to the active/inactive supervision channels of the supervised output channels.

It is possible to operate a smoke control system using only smoke device control elements by defining suitable triggering conditions in the causes elements of the control objects. However, this can become very complex for anything other than the simplest control strategies. For example, consider a smoke zone that is in pressurize mode and a small amount of smoke enters the zone. If the triggering condition for an exhaust device in the zone is simply the activation of a local smoke detector, the device will be activated, invalidating the pressurize mode. This goes against the stability requirement to maintain the mode until manually reset. In this case, a correct triggering condition for the exhaust device would need to check the state of the entire smoke zone.

For this reason, the control panel or control panels 112 of the fire protection system 100 includes smoke zone control elements. The smoke zone control elements enable smoke control strategies that meet even complex stability requirements without excessively complicated triggering conditions. For each smoke zone control element, a causes exhaust element and a causes pressurize element include conditions under which the smoke zone should switch to exhaust or pressurize mode. The exhaust devices or associated smoke device control elements are assigned to the effects exhaust elements of this control. The supply devices and/or associated smoke device control elements are assigned to the effects air supply elements of the control. This ensures that stability requirements are met.

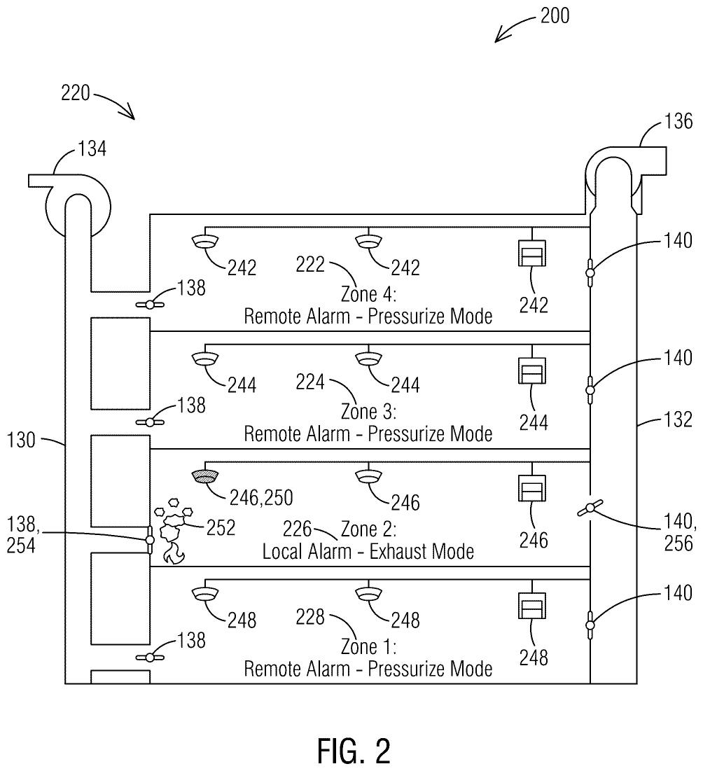

Referring to FIG. 2, there is shown alarm state of the fire protection system 200 associated with a particular zone 226. The alarm area or zone 126 enters exhaust mode and other zones 222, 224, 228 enter pressurized mode to reduce smoke entering these other others. For the exhaust mode, exhaust dampers are substantially open and supply dampers are substantially closed. For pressurized mode, supply dampers are substantially open and exhaust dampers are substantially closed. For example, as shown in FIG. 2, a smoke detector 250 may detect an alarm condition 252 in zone 2 (226) while field devices 242, 244, 246 in other zones 222, 224, 228 do not detect any alarm condition. As a result, the detecting smoke detector 250 may send an alarm signal to the control panel 112 and zone 2 (226) enters the exhaust mode, thereby closing the supply damper 254 and opening exhaust damper 256. In addition, the other zones 222, 224, 228 of the non-detecting smoke detectors 242, 244, 248 enter the pressurize mode, thereby maintaining the supply dampers 138 (except damper 254) open and the exhaust dampers 140 (except damper 256) closed.

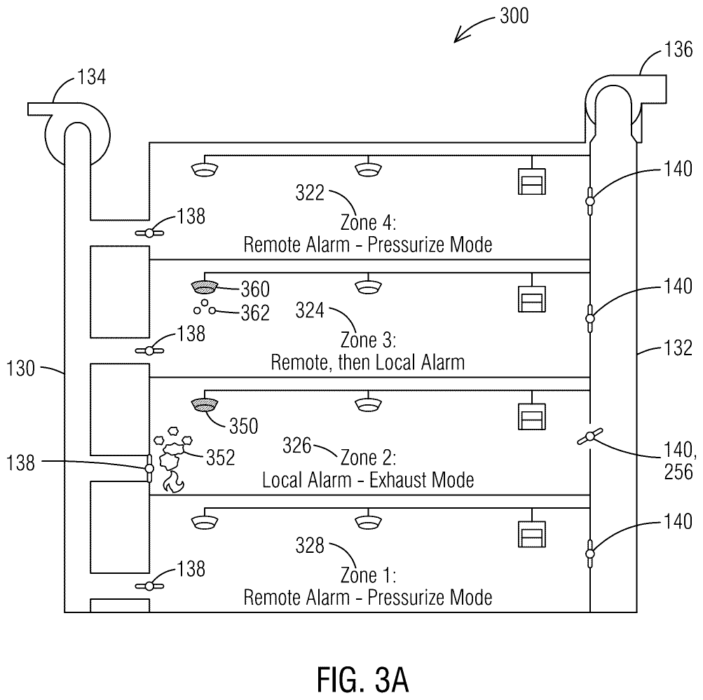

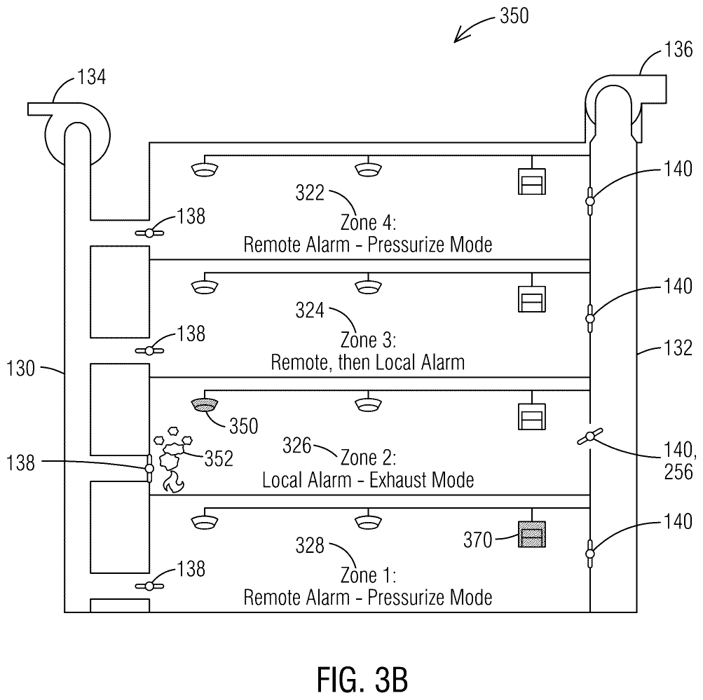

Referring to FIG. 3A, there is shown alarm state of the fire protection system 300 associated with multiple zones 324, 326. For this scenario, a first smoke detector 350 in an exhaust zone may detect an alarm condition 352, and the alarm condition may seep from the exhaust zone to an adjacent pressurize zone, via an opening in a wall, portal, etc. The adjacent pressurize zone should stay in pressurize mode even though the local smoke detector of the pressurize zone detects the alarm condition. This is the stability property in which a zone should not change from its pressurized mode even if a local sensor detects an alarm condition, since the alarm condition is caused by smoke entering from another zone. For example, as shown in FIG. 3A, the first smoke detector 350 may detect a first alarm condition 352 in zone 2 (326) while field devices in other zones 322, 324, 328 do not detect any alarm condition. The first smoke detector 350 may send a first alarm signal to the control panel 112 and zone 2 (326) enters the exhaust mode, while the other zones 322, 324, 328 of the non-detecting smoke detectors enter the pressurize mode. Subsequently, if a second smoke detector 360 of an adjacent zone, namely zone 3 (324), a second alarm condition, the second smoke detector 360 may send a second alarm signal to the control panel 112. The control panel 112 may recognize that the second alarm condition is based on the first alarm condition, i.e., a remote alarm, and informs the second smoke detector accordingly. As a result, zone 3 (324) remains in the pressurize mode thereby maintaining the supply dampers 138 of zone 3 open and the exhaust dampers 140 of zone 3 closed.

Referring to FIG. 3B, there is shown alarm state of the fire protection system 300 associated with a manual alarm of a pull station 370. Although a pull station 370 is located at a particular zone, such as zone 1 (328), the alarm condition may exist at a different location, such as zone 2 (326). For this scenario, when a manual alarm is detected, the actual location of the alarm condition is not known by the control panel 112 or any other part of the fire protection system 100 (without more information). Accordingly, the manual alarm is ignored by the automatic system because the control panel 112, and the system 100 cannot be sure of the actual location of the fire.

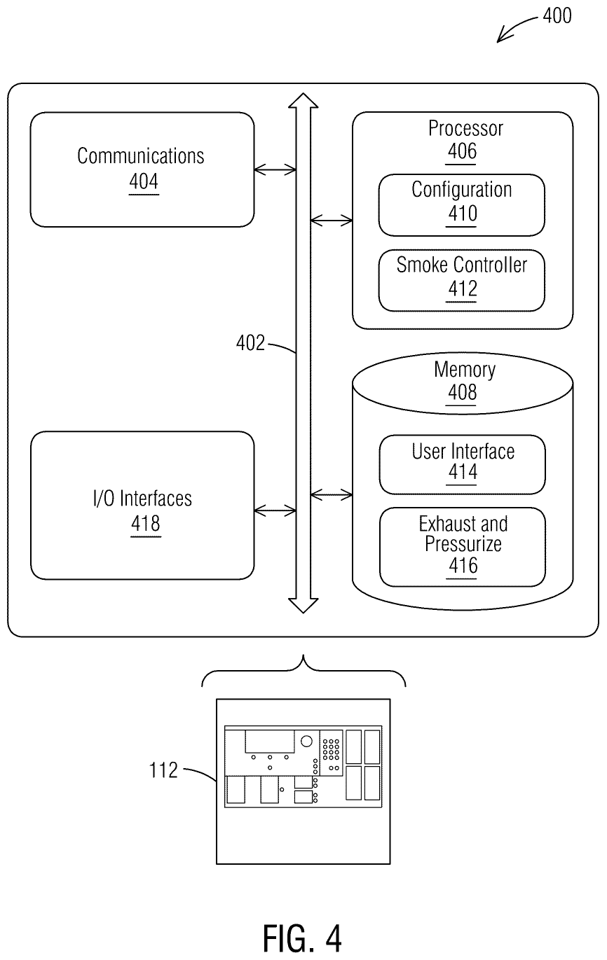

Referring to FIG. 4, there are shown system components 400 of a control panel 112 in an example implementation. The system components 400 comprise one or more communication lines 402 for interconnecting other system components directly or indirectly. The other system components include one or more communication components 404 communicating with other entities via a wired or wireless network, one or more processors 406, and one or more memory components 408. The communication component 404 communicates (i.e., receives and/or transmits) data associated with one or more devices of the system 100 and its associated devices. The communication component 404 may utilize wired or wireless technology for communication.

The processor or processors 406 may send data to, and process commands received from, other components of the system components 400, such as information of the communication component 404 or the memory component 408. Each application includes executable code to provide specific functionality for the processor 406 and/or remaining components of the control panel 112. Examples of applications executable by the processor 406 include, but are not limited to, a configuration module 410 and a smoke controller 412. The configuration module 410 utilizes information received from a workstation remote from the control panel 112 to configure each smoke detector to include smoke device controls and smoke zone controls. The configuration module 410 also configures each smoke controller to include a causes exhaust element, a causes pressurize element, an effects exhaust element, and an effects air supply element. The smoke controller 412 enters an exhaust mode for a first smoke controller in response to determining that an exhaust cause of the first smoke controller is active, enters a pressurize mode for a second smoke controller in response to determining that an exhaust cause of the second smoke controller is non-active and a pressurize cause of the second smoke controller is active, and maintains the exhaust mode of the first smoke controller and the pressurize mode of the second smoke controller in a stable active mode. For the stable active mode, the smoke controller 412 ignores a subsequent alarm signal preceding a reset of the alarm condition. The exhaust mode is entered by activating exhaust effects and deactivating supply effects, and the pressurize mode is entered by activating the supply effects and deactivating the exhaust effects.

Data stored at the memory component 408 is information that may be referenced and/or manipulated by a module of the processor 406 for performing functions of the control panel 112. Examples of data associated with the control panel 112 and stored by the memory component 408 may include, but are not limited to, a user interface 414 and exhaust and pressure data 416. ***

The system components 400 may include an input/output component 418 that manages one or more input components and/or an output component. The input/output components 418 of the system components 400 include wired or wireless connections for communication with field devices of the fire protection system 100. The input component of the input/output component 418 detects an alarm condition of the fire protection system, and the smoke controller 412 performs the functions of entering the exhaust mode or the pressurize mode in response to the alarm condition detected by the input component.

It is to be understood that FIG. 4 is provided for illustrative purposes only to represent an example implementation of the control panel 112 and is not intended to be a complete diagram of the various components that may be utilized by the device. The control panel 112, may include various other components not shown in FIG. 4, may include a combination of two or more components, or a division of a particular component into two or more separate components, and still be within the scope of the present invention. Also, the components 400 may be coupled directly or indirectly to each other to perform the operations of the control panel 112.

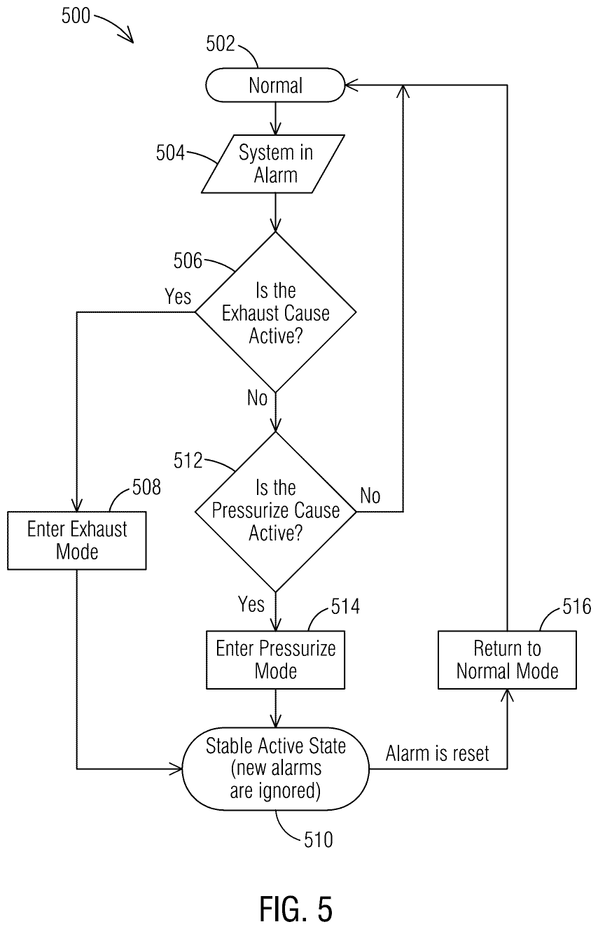

Referring to FIG. 5, there is shown a flow diagram of a smoke control operation 500 of a smoke controller 412 of a control panel in an example implementation. The smoke control operation 500 represents a method of the control panel 112 of the fire protection system 100 in which the control panel includes a smoke controller 412 corresponding to each zone of the facility. The smoke control operation 500 and its smoke controllers 412 may be in a “normal” condition (502) during its operation. During this normal condition (502), the smoke control operation 500 may detect (504) an alarm condition of the fire protection system 100. For some embodiments, a particular or first smoke controller 412 associated with a particular or first zone may receive an alert signal from a field device of the zone.

In response to detecting (504) the alarm condition, the smoke controller 412 determines (506) whether an exhaust cause of the smoke controller is active. For some embodiments, the smoke controller 412 may determine (506) that the exhaust cause is active by (506) determining that the alarm condition is associated with a local alarm corresponding the first smoke controller. In response to determining (506) that the exhaust cause is active, the smoke controller 412 enters (508) an exhaust mode for the first smoke controller. Entering the exhaust mode includes activating exhaust effects and deactivating supply effects. The smoke controller 412 maintains (510) a stable active state until the alarm condition reset by the control panel 112, the management workstation 104, or some other device of the fire protection system 100. The smoke controller 412 may maintain (510) the stable active state regardless of whether the smoke of one zone traverses to an adjacent zone or a manual alarm is identified. For this stable active state, the smoke controller 412 may ignore one or more alarms subsequent to detecting (504) the alarm condition until the alarm is reset.

In response to determining (506) that the exhaust cause is non-active, the smoke controller 412 determines (512) whether a pressurize cause is active. In response to determining (512) that the pressurize cause is active, the smoke controller 412 enters (514) a pressurize mode for a second smoke controller. Accordingly, the smoke controller 412 enters (514) the pressurize mode in response to determining (506) that an exhaust cause of the second smoke controller is non-active and determining (512) that a pressurize cause of the second smoke controller is active. In entering (514) the pressurize mode, the smoke controller 412 activates the supply effects and deactivating the exhaust effects. For some embodiments, the smoke controller 412 determines that the alarm condition is associated with a remote alarm corresponding a smoke controller other than the first smoke controller. After entering (514) the pressurize mode, the smoke controller 412 maintains (510) a stable active state until the alarm condition reset by the control panel 112, the management workstation 104, or some other device of the fire protection system 100. Again, the smoke controller 412 may maintain (510) the stable active state regardless of whether the smoke of one zone traverses to an adjacent zone or a manual alarm is identified. For this stable active state, the smoke controller 412 may ignore one or more alarms subsequent to detecting (504) the alarm condition until the alarm is reset.

The smoke controller 412 of the control panel 112 provides the fire protection system 100 with one or more specialized control elements specifically designed to manage a smoke zone. These control elements oversee and coordinate smoke devices within the zones. To accomplish this, the devices are divided into two groups: the exhaust devices and the supply devices. When activated, the smoke controller 412 can put the smoke zone either in exhaust mode or in pressurize mode by activating the exhaust group and deactivating the supply group or vice versa. This setup ensures that the smoke devices within the same zone are coordinated.

The smoke controller 412 also monitors system events that may trigger either the exhaust or the pressurize mode. If an event occurs, the smoke controller 412 enters the corresponding mode, either exhaust or pressurize. Once activated, the smoke controller 412 will remain in the selected mode unless the initial trigger condition becomes false. This property is key to ensure the stability of the smoke control strategy without the need for additional control elements.

Another noteworthy feature of the control element's evaluation of events is that it implicitly adds the negation of the exhaust conditions to the pressurize conditions: to enter pressurize mode, the control element will check both that the pressurize conditions are true and that the exhaust conditions are false. This approach greatly simplifies the task of configuring the system, as technicians can write expansive pressurize conditions without worrying about potential overlap with the exhaust conditions. For example, one could set the exhaust condition as the activation of local smoke detectors, and the pressurize condition as the presence of a fire alarm in the building. In this scenario, a trigger from a local fire alarm would satisfy both the exhaust and the pressurize conditions, but due to the implicit negation technique described above, namely that the negation of the exhaust condition is a requirement to enter pressurize mode, the zone would enter the exhaust mode as expected. Notably, these simple trigger conditions, a local fire alarm as exhaust condition and any fire alarm in the building as pressurize condition, when applied to all smoke zones, easily implements the “One exhaust-Others pressurized” smoke control strategy mentioned above.

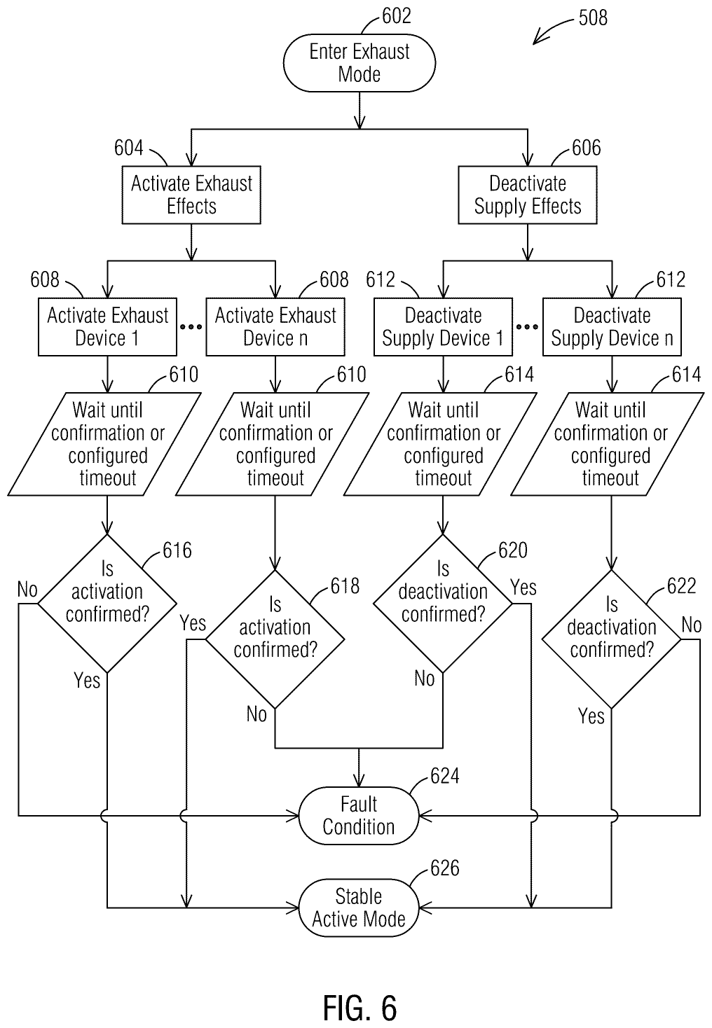

Referring to FIG. 6, the process of entering (508) the exhaust mode is explained in more detail. In response to entering (602) the exhaust mode, the smoke controller 412 activates (604) exhaust effects and deactivates (606) supply effects. The smoke controller 412 activates (608) the exhaust field devices of the zones in response to activating (604) the exhaust effects and awaits (610) either an activation confirmation of the activation or an activation timeout result based on a predetermined activation time period. The smoke controller 412 deactivates (612) the supply field devices of the zone in response in response to deactivating (606) the supply effects and awaits (614) either a deactivation confirmation of the deactivation or a deactivation timeout result based on a predetermined deactivation time period. The smoke controller 412 then determines (616)-(622) whether the activations and the deactivations are confirmed. If all activations and deactivations are confirmed (616)-(622), then the smoke controller 412 maintains (626) the stable active mode. If any of the activations or the deactivations are not confirmed, then the smoke controller 412 identifies (624) a fault condition. For some embodiments, the control panel 112 includes a fault condition module to operation fault detection and diagnostics in response to the fault condition.

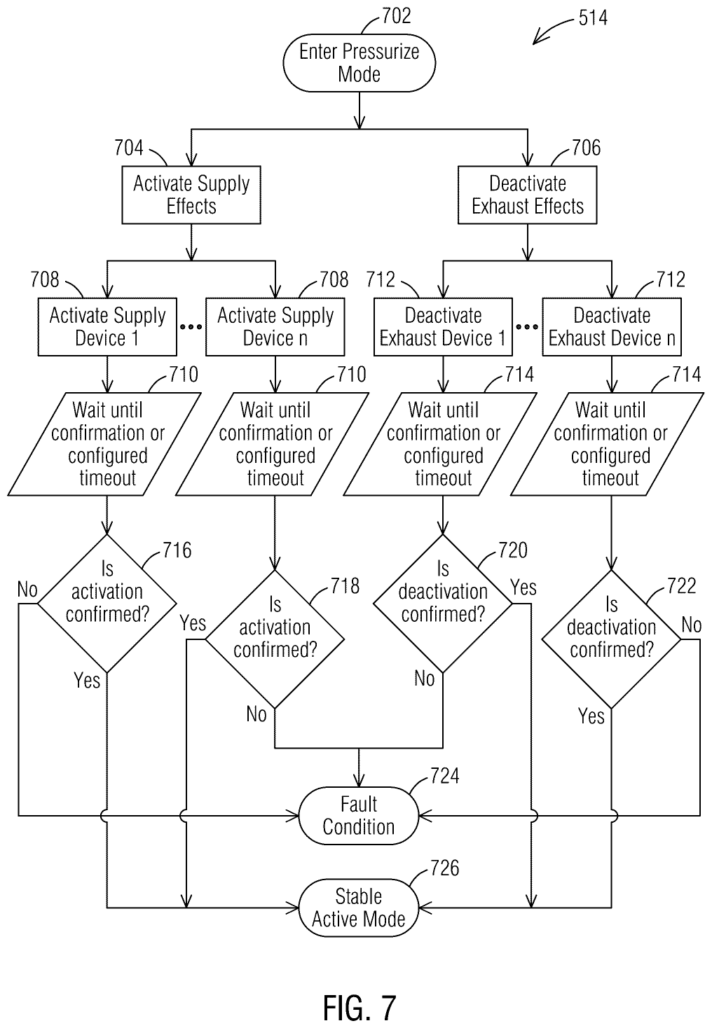

Referring to FIG. 7, the process of entering (514) the pressurize mode is explained in more detail. In response to entering (702) the pressurize mode, the smoke controller 412 activates (704) supply effects and deactivates (706) exhaust effects. The smoke controller 412 activates (708) the supply field devices of the zones in response to activating (704) the supply effects and awaits (710) either an activation confirmation of the activation or an activation timeout result based on a predetermined activation time period. The smoke controller 412 deactivates (712) the exhaust field devices of the zone in response in response to deactivating (706) the exhaust effects and awaits (714) either a deactivation confirmation of the deactivation or a deactivation timeout result based on a predetermined deactivation time period. The smoke controller 412 then determines (716)-(722) whether the activations and the deactivations are confirmed. If all activations and deactivations are confirmed (716)-(722), then the smoke controller 412 maintains (726) the stable active mode. If any of the activations or the deactivations are not confirmed, then the smoke controller 412 identifies (724) a fault condition. For some embodiments, the control panel 112 includes a fault condition module to operation fault detection and diagnostics in response to the fault condition.

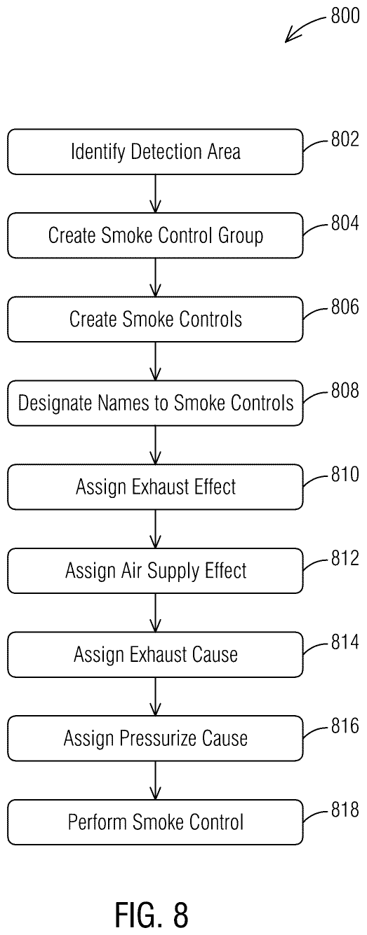

Referring to FIG. 8, there is shown a configuration operation 800 of the smoke zone control system to create smoke zones with smart controls. The smart controls have built-in knowledge of smoke control, allowing for quick smoke control configurations. For the configuration operation 800, the system identifies (802) a detection area. The detection area may be created by setting one or more alarm zones of the facility. The system may then create (804) a smoke control group in a control tree of the system.

Based on the configuration operation 800, the system creates (806) smoke controls associated with the smoke control group and the detection area. In particular, the smoke control group includes a smoke device control for the exhaust device(s), a smoke device control for the air supply device(s), and a smoke zone control to coordinate the device controls and implement the smoke control strategy. The smoke device control for exhaust, the smoke device control for air supply, and the smoke zone control are created for each detection area. For some embodiments, the system may allow a user or operator to designate (808) a name for one or more device controls and/or zone controls to facilitate human readability and understanding of these smoke controls.

Continuing with the configuration operation 800, the system assigns (810-816) elements to the smoke controls. The smoke zone control of the smoke control group includes causes exhaust, causes pressurize, effects exhaust, and effects air supply. The system may assign (810) the exhaust effect to the smoke device control associated with the exhaust device(s). The system may then assign (812) the air supply effect to the smoke device control associated with the air supply devices. After completing assignments for the effects elements, the system may assign (814, 816) the causes elements. The exhaust causes may be assigned (814) to each automatic alarm zone of the detection area. The pressurize causes may be assigned (816) to the automatic alarm for the entire facility. The zone controls are smart since they have knowledge of the smoke control. In particular, the system only pressurize the alarm zones of the detection area that do not have a local fire event. Once configured, the system may perform (818) the smoke control operation for the facility when needed.

The system utilizes a smoke zone control element, the stability property of this element, and the implicit negation technique, provide significant performance, efficiency, and cost advantages compared to known solutions/products. The improved coordination, simplified stability enforcement, and streamlined configuration contribute to the overall effectiveness and cost-effectiveness of the fire control system.

Those skilled in the art will recognize that, for simplicity and clarity, the full structure and operation of all data processing systems suitable for use with the present disclosure are not being depicted or described herein. Also, none of the various features or processes described herein should be considered essential to any or all embodiments, except as described herein. Various features may be omitted or duplicated in various embodiments. Various processes described may be omitted, repeated, performed sequentially, concurrently, or in a different order. Various features and processes described herein can be combined in still other embodiments as may be described in the claims.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an example embodiment of the present disclosure has been described in detail, those skilled in the art will understand that various changes, substitutions, variations, and improvements disclosed herein may be made without departing from the spirit and scope of the disclosure in its broadest form.

1. A method of a control panel of a fire protection system having a plurality of smoke controllers, the plurality of smoke controllers corresponding to a plurality of zones of a facility, the method comprising:
detecting an alarm condition of the fire protection system;
entering an exhaust mode for a first smoke controller of the plurality of smoke controllers in response to determining that an exhaust cause of the first smoke controller is active, entering the exhaust mode includes activating exhaust effects and deactivating supply effects;
entering a pressurize mode for a second smoke controller of the plurality of smoke controllers in response to determining that an exhaust cause of the second smoke controller is non-active and a pressurize cause of the second smoke controller is active, entering the pressurize mode includes activating the supply effects and deactivating the exhaust effects; and
maintaining the exhaust mode of the first smoke controller and the pressurize mode of the second smoke controller in a stable active mode.

2. The method as described in claim 1, wherein detecting the alarm condition of the first protection system includes receiving an alert signal from a field device of a zone.

3. The method as described in claim 1, wherein determining that the exhaust cause of the first smoke controller is active includes determining that the alarm condition is associated with a local alarm corresponding the first smoke controller.

4. The method as described in claim 1, wherein determining that the pressurize cause of the second smoke controller is active includes determining that the alarm condition is associated with a remote alarm corresponding a smoke controller of the plurality of smoke controllers other than the first smoke controller.

5. The method as described in claim 1, wherein maintaining the exhaust mode of the first smoke controller and the pressurize mode of the second smoke controller in the stable active mode includes ignoring a subsequent alarm signal preceding a reset of the alarm condition.

6. The method as described in claim 1, further comprising configuring each smoke controller of the plurality of smoke controllers, via workstation remote from the control panel, to include a plurality of smoke device controls and a plurality of smoke zone controls.

7. The method as described in claim 1, further comprising configuring each smoke controller of the plurality of smoke controllers to include a causes exhaust element, a causes pressurize element, an effects exhaust element, and an effects air supply element.

8. A control panel of a fire protection system comprising:
a plurality of smoke controllers, the plurality of smoke controllers corresponding to a plurality of zones of a facility;
an input component configured to detect an alarm condition of the fire protection system;
a processor configured to:
enter an exhaust mode for a first smoke controller of the plurality of smoke controllers in response to determining that an exhaust cause of the first smoke controller is active,
enter a pressurize mode for a second smoke controller of the plurality of smoke controllers in response to determining that an exhaust cause of the second smoke controller is non-active and a pressurize cause of the second smoke controller is active, and
maintaining the exhaust mode of the first smoke controller and the pressurize mode of the second smoke controller in a stable active mode,
wherein the exhaust mode is entered by activating exhaust effects and deactivating supply effects, and the pressurize mode is entered by activating the supply effects and deactivating the exhaust effects.

9. The control panel as described in claim 8, wherein the input component detects the alarm condition of the first protection system by receiving an alert signal from a field device of a zone.

10. The control panel as described in claim 8, wherein the processor determines that the alarm condition is associated with a local alarm corresponding the first smoke controller.

11. The control panel as described in claim 8, wherein the processor determines that the alarm condition is associated with a remote alarm corresponding a smoke controller of the plurality of smoke controllers other than the first smoke controller.

12. The control panel as described in claim 8, wherein maintains the exhaust mode of the first smoke controller and the pressurize mode of the second smoke controller in the stable active mode by ignoring a subsequent alarm signal preceding a reset of the alarm condition.

13. The control panel as described in claim 8, further comprising a workstation remoted from the control panel configuring each smoke controller of the plurality of smoke controllers to include a plurality of smoke device controls and a plurality of smoke zone controls.

14. The method as described in claim 8, further comprising configuring each smoke controller of the plurality of smoke controllers to include a causes exhaust element, a causes pressurize element, an effects exhaust element, and an effects air supply element.

15. A non-transitory computer readable medium including executable instructions which, when executed, causes at least one processor to manage a plurality of smoke controllers for a control panel of a fire protection system by:
detecting an alarm condition of the fire protection system;
entering an exhaust mode for a first smoke controller of the plurality of smoke controllers in response to determining that an exhaust cause of the first smoke controller is active, entering the exhaust mode includes activating exhaust effects and deactivating supply effects;
entering a pressurize mode for a second smoke controller of the plurality of smoke controllers in response to determining that an exhaust cause of the second smoke controller is non-active and a pressurize cause of the second smoke controller is active, entering the pressurize mode includes activating the supply effects and deactivating the exhaust effects; and
maintaining the exhaust mode of the first smoke controller and the pressurize mode of the second smoke controller in a stable active mode.

16. The non-transitory computer readable medium as described in claim 15, wherein detecting the alarm condition of the first protection system includes receiving an alert signal from a field device of a zone.

17. The non-transitory computer readable medium as described in claim 15, wherein determining that the exhaust cause of the first smoke controller is active includes determining that the alarm condition is associated with a local alarm corresponding the first smoke controller.

18. The non-transitory computer readable medium as described in claim 15, wherein determining that the pressurize cause of the second smoke controller is active includes determining that the alarm condition is associated with a remote alarm corresponding a smoke controller of the plurality of smoke controllers other than the first smoke controller.

19. The non-transitory computer readable medium as described in claim 15, wherein maintaining the exhaust mode of the first smoke controller and the pressurize mode of the second smoke controller in the stable active mode includes ignoring a subsequent alarm signal preceding a reset of the alarm condition.

20. The non-transitory computer readable medium as described in claim 15, further comprising configuring each smoke controller of the plurality of smoke controllers, via workstation remote from the control panel, to include a plurality of smoke device controls and a plurality of smoke zone controls, wherein the smoke zone controls include a causes exhaust element, a causes pressurize element, an effects exhaust element, and an effects air supply element.
